(19) United States
(12) Patent Application Publication
(10) Pub. No.: US 2007/0239897 A1
(43) Pub. Date: Oct. 11, 2007

(54) Compressing or decompressing packet communications from diverse sources

(76) Inventors: Michael A. Rothman, Sammamish, WA (US); Vincent J. Zimmer, Federal Way, WA (US)

Correspondence Address: TROP PRUNER & HU, PC, 1616 S. VOSS ROAD, SUITE 750, HOUSTON, TX, 77057-2631, US

(21) Appl. No.: 11/392,406

(22) Filed: Mar. 29, 2006

(51) Int. Cl. G06F 15/16

(52) U.S. Cl. 709/247

(57) ABSTRACT

Compressed input/output communications may be handled without requiring any alteration of system topology. In some embodiments, when a communication is received by a device such as a network interface card, an alert may be provided to an agent that may handle compression or decompression, independently of a main operating system and a main partition. For example, compression may be handled by a sequestered partition or a virtual machine monitor, as two examples. These agents may then decide whether to compress or decompress and how to do so in some cases. As a result, the handling of compressed communications may be offloaded to a separate processor which may be dedicated to that task.

### BACKGROUND

This invention relates generally to processor-based systems and for systems for communicating between processor-based systems.

In processor-based systems, communications may occur between any one system and a server and other processor-based systems. Often, such communications are undertaken through network interface cards, for example.

The speed of such communications may tend to be relatively limited, especially when relatively high amounts of data are being transmitted. Thus, there is a need for better ways to facilitate and improve the speed of data transmission.

In many cases, the data originators and receivers may be diverse. These data receivers and data originators may use different data protocols so that the data may be contained in formats which are equally diverse.

Existing network interface cards are capable of relatively limited manipulation of data. Their processing power is generally low and their ability to accommodate diverse originating or receiving devices may be relatively limited.

### BRIEF DESCRIPTION OF THE DRAWINGS

FIG. 1 is a system depiction in accordance with one embodiment of the present invention;

FIG. 2 is another system depiction in accordance with another embodiment of the present invention;

FIG. 3 shows a data conversion protocol in accordance with one embodiment of the present invention;

FIG. 4 shows a non-point-to-point compression system in accordance with one embodiment of the present invention;

FIG. 5 is a high level depiction of still another embodiment of the present invention; and

FIG. 6 is a flow chart in accordance with one embodiment of the present invention.

### DETAILED DESCRIPTION

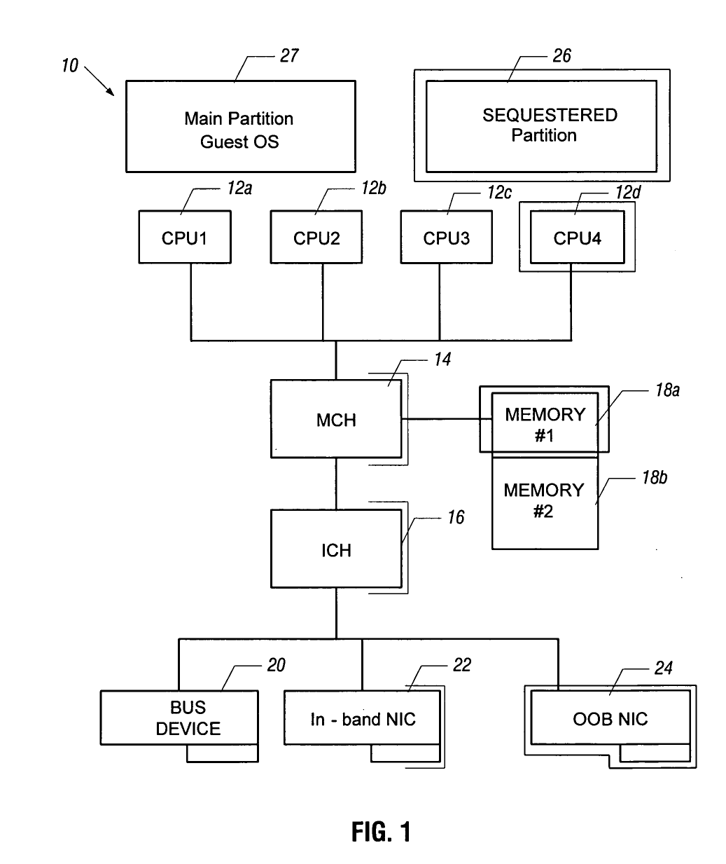

Referring to FIG. 1, a system 10 may include a plurality of central processing units 12a, 12b, 12c, and 12d. While four central processing units are illustrated in one embodiment of the present invention, more or less central processing units may be utilized.

In some embodiments, the central processing units 12a-12d may be contained within one package. As another embodiment, the central processing units may each be associated with separate packets and separate sockets connected to the same motherboard.

The central processing units 12a-12d may be coupled to a memory controller hub (MCH) 14. In some embodiments, the memory controller hub may be a separate integrated circuit, separate from the central processing units 12a-12d. The memory controller hub may communicate with memories 18a and 18b in one embodiment. The memory 18a and 18b may be a dynamic random access memory or a state random access memory, as two examples.

The memory controller hub 14 may also communicate with an input/output controller hub (ICH) 16. The controller hub 16 may communicate via a bus with various bus devices represented by the bus device 20, an in-band network interface card 22, and an out-of-band network interface card 24. The in-band network interface card 22 and out-of-band network interface card 24 may be conventional in all respects. Moreover, in some embodiments, no hardware change may be required to the system 10.

In some embodiments of the present invention, non-point-to-point communications may be compressed, despite the fact that the sending and receiving devices may operate with different protocols and have different requirements. The manipulation and coordination of such compression activities may be done, in one embodiment, using an agent that can act independently of a main partition of the system 10 and/or its operating system. For example, the independent agent may be a sequestered partition 26.

The sequestered partition 26 may be established independently of a main partition 27 and independently of the system 10 operating system. Thus, the sequestered partition may operate totally invisibly to the main operating system and the main partition 27 in some embodiments of the present invention. In this way, it can handle compression duties at the same time the main operating system and main partition 27 are undertaking other activities. In one embodiment, this is possible because of the presence of multiple processing units 12a-12d. For example, the processing unit 12d may be dedicated to handling the duties assigned to it by the sequestered partition. In some embodiments, those duties may involve handling of compression and decompression.

In one embodiment, the sequestered partition may receive information anytime any entity tries to send or receive data through a communication portal such as one of the network interface cards 22 or 24. When either of those cards 22 or 24 receives a communication, that information results in an alert being generated, for example, by the memory controller hub 14 or I/O controller hub 16 to the sequestered partition 26. The sequestered partition then decides whether to compress an outgoing communication or to decompress an incoming communication. If it decides to compress or decompress, the sequestered partition may enable compression or decompression to be done by a dedicated central processing unit such as the unit 12d.

This compression or decompression may be accomplished as a separate activity, totally sequestered and hidden from the main operating system and the main partition 27. As a result, the compression or decompression may be implemented without main operating system involvement and regardless of system resources in some embodiments. In other words, network interface cards that normally are involved in point-to-point type communications with limited capabilities may now be capable of being involved in communications with both compressed or decompressed data without main partition involvement and without any substantial hardware redesign, in some embodiments. As used herein, a point-to-point communication is a communication via link in which dedicated links exist between individual origins and destinations.

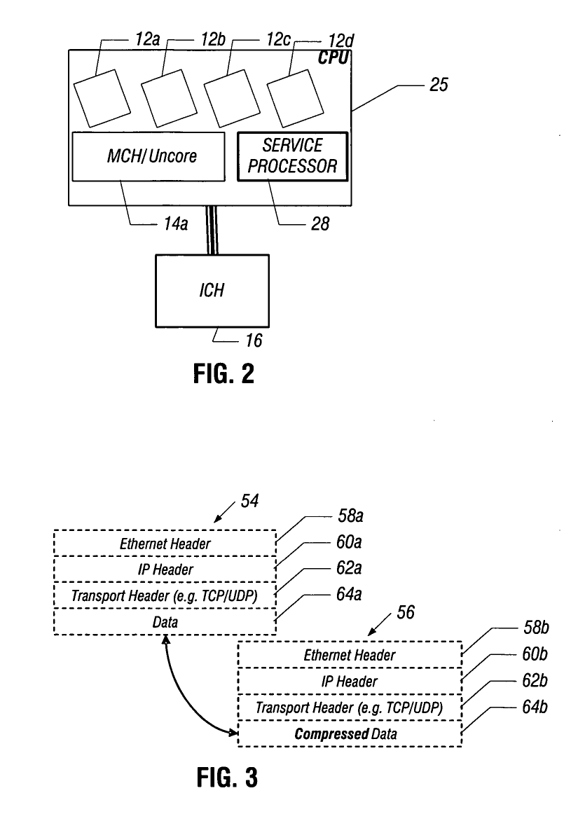

In accordance with one variation, shown in FIG. 2, instead of using separate central processing units 12a-12d, a series of units 12a-12d formed on the same integrated circuit 25 may be used. Again, the number of cores is not of any importance to the invention and more or fewer cores may be provided. Also provided on the same integrated circuit 25, in one embodiment, may be a memory controller hub/uncore 14a. The memory controller hub/uncore may implement activities previously handled by a separate memory controller hub integrated circuit and devices coupled to the memory controller hub, such as the memory 18a and memory 18b, which may have been independent integrated circuits. The functionality of the memory controller hub and associated functions may all be integrated into the same integrated circuit that includes the units 12a-12d in one embodiment.

Also provided on the same integrated circuit chip, in some embodiments, may be service processor 28. For example, the service processor 28 may enable remote management of a platform 10. The service processor 28 may enable monitoring of various conditions, such as temperature and processor operating speed, to enable remote control of the system 10, as well as remote diagnostics and repair.

The integrated circuit 25 may then be coupled to a separate ICH 16. The ICH 16 may be a separate integrated circuit in one embodiment.

Thus, in some embodiments, a packet 54, indicated in FIG. 3, may arrive at the system 10 with an Ethernet header 58a, as one example. It may also include an Internet Protocol header 60a and a transport header 62a, as well as payload or actual data 64a. The packet 54 may be converted by the sequestered partition 26 in conjunction with the central processing unit 12d into a packet 56 which includes compressed data 64b, but otherwise includes headers 58b, 60b, and 62b, and transport data which may be the same or similar to headers included in the packet 54. In some cases, the headers 58b, 60b, and 62b may be modified to indicate that compressed data is contained in the packet.

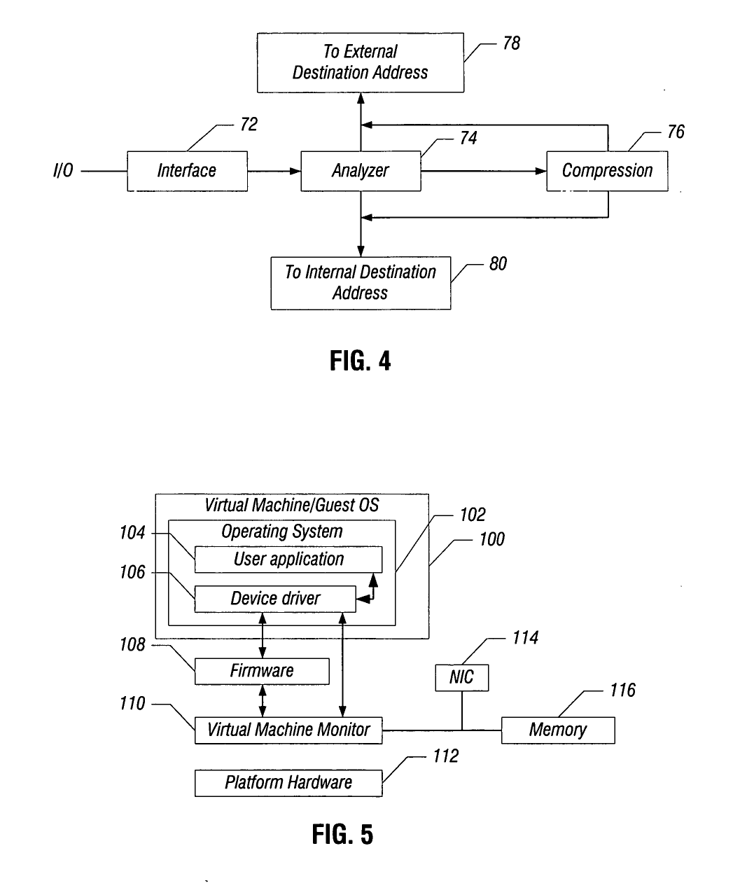

Thus, referring to FIG. 4, in accordance with some embodiments of the present invention, when an input or output communication is received by a card 22 or 24, an interface 72 provides information about that communication to an analyzer 74. The analyzer 74 may be a sequestered partition 26 in one embodiment. As another example, the analyzer 74 may be a virtual machine monitor which intercepts the communication and analyzes that communication. The analyzer 74, in any case, decides whether to compress or not to compress in compression or decompression device 76 and to receive the information from an internal destination address 80 or to send compressed or uncompressed data to an external destination 78.

These communications need not be point-to-point. Any device within the platform 10 may transmit or receive data from any remote device. The sending and receiving devices may not use the same protocols and point-to-point communication is not required. In all these cases, communication of compressed data may be implemented nonetheless.

Thus, referring to FIG. 5, in accordance with another embodiment of the present invention, a virtual machine monitor 110 may be used to do some or all of the activities that the sequestered partition 26 does in the embodiment of FIG. 1. The virtual machine monitor 110 may be coupled to a network interface card 114 and a memory 116 in one embodiment. It may also be coupled to firmware 108 which, in turn, is coupled to a device driver 106. The virtual machine monitor 110 may also communicate with the device driver 106. The device driver 106 may communicate with user applications 104. The device drivers and the user applications may be part of an operating system 102. The virtual machine 100 or guest operating system may facilitate the entire operation and enable communications with platform hardware 112.

In the case of the virtual machine, an intelligent agent is used as an intermediary that is actually deciding whether compressed communications are appropriate and is actually implementing the compressed communications. Conversely, in the case of the sequestered partition, the intermediary is not necessarily the intelligent agent, but simply passes the compression job onto a central processing unit to handle.

When a platform, such as a platform 10, boots up, it may represent the network interface card. The network interface card may be associated or dedicated to a sequestered partition that is not exposed to the operating system. The platform may then describe the network interface card as a pseudo device with a physical location. The main partition sees a pseudo device and can communicate with it. For example, an ICH may forward I/O requests directed to the pseudo device instead to the sequestered partition. The pseudo device may act as a proxy to alert a sequestered partition. Reads or writes go first to the pseudo device which then directs them to the sequestered partition. Only the sequestered partition has access to the real device such as the in-band network interface card 22 of FIG. 1. The sequestered partition acts like an operating system to direct the network interface card to receive or send communications.

In the sequestered partition embodiment, the ICH may act as a proxy for certain registered devices, generating alerts to the sequestered partition when attempts are made to access a registered card 22 or 24. The alert is routed to the sequestered partition for handling.

In contrast, with the virtual machine monitor, the virtual machine monitor acts as a proxy for hardware intercepts. The virtual machine monitor gets alerts when a communication is directed to a hardware component device and decides how to represent this event to the guest operating system. The monitor can simply pass through the request to hardware devices or may manipulate the request, for example, generating compressed packets.

Referring back to FIG. 1, double lines indicate components which, in some embodiments, may be dedicated to the sequestered partition 26. These may include the central processing unit 12d, the memory 18a, a portion of the MCH 14, a portion of the ICH 16, the out-of-band network interface card 24, and a portion of the in-band network interface card 22. Of course, other arrangements are possible as well.

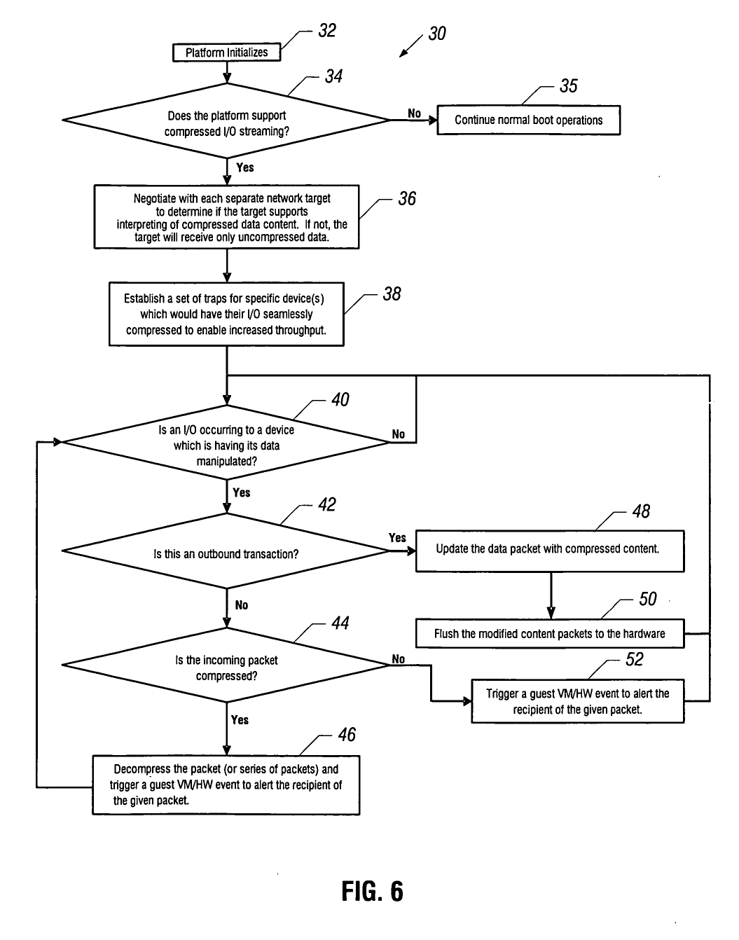

Referring now to FIG. 6, the process 30 for operation of one embodiment of the present invention is illustrated. It may be implemented in software, hardware, or firmware. For example, it may be stored in the memory 18a for execution by the central processing unit 12d. Alternatively, it may be stored in other memories for implementation of the virtual machine monitor 110. In other embodiments, it may be part of a memory controller hub 14 or even the ICH 16.

At block 32, the platform initializes. The first check is whether the platform supports compressed input/output (I/O) streaming (diamond 34). If it does not, a normal boot operation proceeds as indicated in block 35.

If compressed I/O streaming is supported, each separate network target undergoes a negotiation (block 36) to determine if the target supports interpreting of compressed data content, in one embodiment. If not, the target will receive only uncompressed data. As indicated in block 36, in some cases, each network target may be set up, for example, in a map associated with a virtual machine monitor or a sequestered partition to indicate which target devices can handle compressed data content and which cannot. Then, when it comes time to make the decision whether to use compression, the ability of the targets to handle compressed data can be consulted.

Referring next to block 38, a set of traps may be set for specific devices which would have their input/output communications seamlessly compressed to enable increased throughput. In other words, any time a communication comes to one of the targeted devices that can handle compressed data, a trap is set to notify either the sequestered partition, the virtual machine monitor, or some other agent which is responsible for implementing non-point-to-point communication compression.

Next, referring to diamond 40, a check determines whether an I/O is actually occurring to a specific targeted device which is having its data manipulated or is otherwise available for compression. If not, the flow recycles. However, if an I/O is occurring to a device that could handle compressed data, a check at diamond 42 determines whether the I/O is an outbound transaction. If so, the data packet may be updated (block 48) with the compressed data, for example, as indicated in FIG. 3. In some embodiments, this may involve buffering a series of packets to properly establish a compression dictionary and then to resend the packets.

In other words, in some cases, some tuning of when and how to do compression may be undertaken. Sometimes the amount of data involved may be so small that the overhead associated with compression may be inefficient. In such cases, it may be decided to forego compression. In other cases, the need for highly reliable data or high speed communications may militate in particular cases for or against compression. Thus, in some cases, a tuning algorithm may take into account characteristics, local conditions, and other criteria to decide whether and how to implement compression. For example, a variety of compression algorithms may be available and the tuning may involve selecting the best compression algorithm for a specific situation. As another example, the need for highly reliable data may affect what compression may be undertaken. As still another example, it may be desirable to achieve a predetermined transmission speed improvement and the data may be manipulated to best achieve that target speed improvement. All this may go into considerations of how long to buffer the packets before deciding how to compress.

Then, referring to block 50, the modified content packets are flushed to the hardware to actually proceed onto their intended destination. Thereafter, the flow recycles back to diamond 40.

On the other hand, if the transaction is not an outbound transaction, a check at diamond 44 determines that the packet is an incoming packet. It then may decide if the packet is compressed. If so, the packet or series of packets may be decompressed as indicated in block 46. A guest virtual machine or hardware event may then be triggered to alert recipients of a given packet. For example, in one embodiment, the virtual machine monitor may be notified and, in another embodiment, the sequestered partition may be notified. Still other embodiments may use different agents which may intervene to provide non-point-to-point decompression.

The packet that arrives that has been compressed may be replaced with N number of packets with uncompressed data to facilitate seamless underlying operations.

On the other hand, if the incoming packet is not compressed, a guest virtual machine or hardware may be triggered to alert the receipt of the given packet (block 52). In other words, the network interface card or other receiving device may be alerted without involvement of some intervening entity such as a sequestered partition, virtual machine monitor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving an indication that a packet has been received at a device; and
determining whether to compress or decompress the packet using a processor dedicated to compression or decompression.

2. The method of claim 1 including using a sequestered partition to determine whether to handle the packet through a dedicated processor for purposes of compression or decompression.

3. The method of claim 1 including using a virtual machine monitor to determine whether to handle the packet through a dedicated processor.

4. The method of claim 1 including selecting a compression algorithm to compress the packet.

5. The method of claim 1 including converting at least one header on said packet and compressing data in said packet.

6. The method of claim 1 including selectively compressing packets based at least in part on a characteristic of said packet.

7. The method of claim 1 including receiving an indication that a packet has been received from a network interface card.

8. The method of claim 1 including determining whether to handle the packet through a dedicated processor using an agent independent of a main operating system.

9. The method of claim 1 including using a dedicated central processing unit to handle compression.

10. A computer readable medium storing instructions that, if executed, cause a system to:
receive an indication that a packet has been received at a device; and
determine whether to compress or decompress the packet using a processor dedicated to compression or decompression.

11. The medium of claim 10 further storing instructions to use a sequestered partition to determine whether to handle the packet through a dedicated processor for purposes of compression or decompression.

12. The medium of claim 10 further storing instructions to use a virtual machine monitor to determine whether to handle the packet through a dedicated processor.

13. The medium of claim 10 further storing instructions to select a compression algorithm to compress the packet.

14. The medium of claim 10 further storing instructions to convert at least one header on said packet and compress data in said packet.

15. The medium of claim 10 further storing instructions to selectively compress packets based at least in part on a characteristic of said packet.

16. The medium of claim 10 further storing instructions to receive an indication that a packet has been received from a network interface card.

17. The medium of claim 10 further storing instructions to determine whether to handle the packet through a dedicated processor using an agent independent of a main operating system.

18. The medium of claim 10 further storing instructions to use a dedicated central processing unit to handle compression.

19. An apparatus comprising:
an analyzer to analyze a communication received by an agent to determine whether data should be compressed or decompressed; and
a central processing unit, coupled to said analyzer, said unit dedicated to compression or decompression.

20. The apparatus of claim 19 wherein said analyzer includes a virtual machine monitor.

21. The apparatus of claim 19 wherein said analyzer includes a sequestered partition.

22. The apparatus of claim 19 including an integrated circuit package, said processor and said analyzer being contained within said package.

23. The apparatus of claim 22, said package including at least one additional processor.

24. The apparatus of claim 23 wherein said package includes a memory controller hub.

25. The apparatus of claim 24 wherein said package includes a service processor.

26. A system comprising:
a first central processing unit;
a second central processing unit;
a network interface card coupled to at least one of said processors; and
an analyzer coupled to at least one of said central processing units to analyze a communication received by said card and to determine whether data should be compressed or decompressed by at least one of said central processing units.

27. The system of claim 26 wherein said first central processing unit is dedicated to compression and decompression and said second central processing unit is responsible for operating said system.

28. The system of claim 26 wherein said analyzer includes a virtual machine monitor.

29. The system of claim 26 wherein said analyzer includes a sequestered partition.

30. The system of claim 26 including an integrated circuit package, said processors and said analyzer being contained within said package.
